(19) United States
(12) Patent Application Publication
(10) Pub. No.: US 2008/0210725 A1
(43) Pub. Date: Sep. 4, 2008

(54) Roof Rail

(75) Inventors: Simon Peter Birtwisle, South Yorkshire (GB); Peter Alexander Hall, South Yorkshire (GB)

Correspondence Address: VENABLE LLP, P.O. BOX 34385, WASHINGTON, DC, 20043-9998, US

(73) Assignee: THULE AUTOMOTIVE LIMITED, Parkgate (GB)

(21) Appl. No.: 11/578,426

(22) PCT Filed: Apr. 15, 2005
(86) PCT No.: PCT/GB05/01452

§ 371 Date: Jan. 3, 2008

(30) Foreign Application Priority Data
Apr. 16, 2004 (GB) 0408639.3

(51) Int. Cl. B60R 9/04

(52) U.S. Cl. 224/309; 29/592; 703/1

(57) ABSTRACT

A roof rail for a vehicle. The roof rail comprises a tubular member having a longitudinal axis, a first end and a second end. The cross-sectional shape and size of the tubular member is substantially constant from the first end to the second end. A portion of the tubular member deviates from the longitudinal axis in the form of at least one twist.

The present invention relates to a roof rail. The invention relates particularly to a roof rail suitable for a vehicle. The invention further relates to a method of manufacturing a roof rail.

Roof rails are used to carry large or bulky items on the roof of a vehicle. They generally consist of at least two metal tubes, which extend in parallel with each other along opposite sides of the roof. The roof rail can be mounted on the roof as either an integrated type of rail or an elevated type of rail. The integrated rail is fitted so as to appear to be in contact with the roof. In this integrated arrangement there is no visible space between the roof rail and the vehicle. The elevated rail is raised from the roof on supports, or feet, which are inserted into the ends of the metal tubing by way of a nose or peg. Therefore, the supports are not an integral part of the metal tubing and have to be attached to the roof rail during manufacture. In this elevated arrangement there is a substantial space between the roof rail tube and the vehicle roof allowing the observer to see through.

EP 657324 shows an elevated type roof rail, which is attached to the vehicle roof by a visible support mounted underneath the tube. The support is fitted on the underside of the rail in the region of a bend in the tube. In this type of arrangement, the support can be unsightly to the consumer and may not suit the styling requirements of many vehicle designers. Further, as the support is separate to the rail, it has to be fitted to the rail before the rail can be fitted to the vehicle.

It is known from the prior art to provide a roof rail having integrally formed supports. Such roof rails are made using a technology known as hydroforming, which utilises internal hydraulic pressure to expand a metal tube into the shape of a roof rail. This method can be employed to produce an elevated roof rail that sits above the roof with two or more rail feet in contact with the body as shown in U.S. Pat. No. 6,250,528. Alternatively, a hydroformed roof rail can be made to appear to be integrated with the roof by being in close contact with the roof along its entire length. However, hydroforming is a particularly expensive process when applied to roof rails because of the need for a high investment in tooling and the parts often require significant polishing to achieve an acceptable surface finish. In particular, hydroformed tubular parts are characterised by having varying cross-sectional size and shape. Further, hydroforming is an expensive process and therefore it is not suitable for all makes and models of vehicle.

It is an object of the present invention to provide a roof rail that is simple and cost-effective to manufacture and which comprises a minimal number of parts.

According to a first aspect of the invention an integrated-type roof rail for a vehicle is provided comprising a tubular member having a longitudinal axis, a first end, a second end, the first end in close proximity to a vehicle roof, a first portion adjacent and integral with the first end, the first portion deviating from the longitudinal axis so as to form a bend, the tubular member further comprising a second portion adjacent and integral with the second end, wherein the cross-sectional shape and size of the tubular member is substantially constant from the first end to the second end. Provision of a roof rail from a single continuous tube of substantially constant cross-sectional shape and size enables the cost of manufacturing to be kept to a minimum, whilst simultaneously enhancing the aesthetic appeal of the rail.

Preferably, the first portion deviates from the longitudinal axis so as to form a curved taper towards a vehicle roof. Preferably, the second portion runs generally parallel to the roof of a vehicle. Preferably, the first end is shaped so as to match the curvature of a vehicle roof. More preferably, the first end is cut to match the curvature of the vehicle roof. Preferably, the first end is spaced less than 15 mm from a vehicle roof. In a most preferred arrangement, the first end is spaced less than 3 mm from a vehicle roof. Preferably, an end cap is provided on the second end to give a complete and finished appearance to the rail. Preferably, the entire tubular member appears to be in contact with the vehicle roof.

Preferably, fixing means are provided to fix at least a part of the tubular member to a vehicle roof. Preferably, the fixing means are double ended threaded studs. Preferably, the double-ended threaded studs have a flange that acts as a small spacer between the roof rail and the roof panel. Advantageously, the spacer compensates for manufacturing tolerances of the roof rail and vehicle body. Alternatively, the fixing means is another type of threaded stud or mechanical fastener. Alternatively, the fixing means is an adhesive bond between the roof rail and the vehicle roof.

Preferably, an extrusion or moulding, preferably, manufactured from rubber, polymer, or rubber foam, is used between the roof rail and a vehicle roof. This gives the appearance of an even distance, and hides any gap, between the rail and the roof but also prevents foreign objects from being lodged between the rail and roof. More preferably, a two-component polymer extrusion is used. Preferably, the tubular member has an R-shaped cross-section. This has the advantage that a lateral cross bar may be readily clamped to the roof rail.

According to a second aspect of the invention an integrated-type roof rail for a vehicle is provided comprising a tubular member having a longitudinal axis, a first end, a second end, the first end in close proximity to the vehicle roof, a first portion adjacent and integral with the first end, the first portion deviating from the longitudinal axis so as to form a bend, the tubular member further comprising a second portion adjacent and integral with the second end, the second end in close proximity to the vehicle roof, the second portion deviating from the longitudinal axis so as to form a bend, wherein the cross-sectional shape and size of the tubular member is substantially constant from the first end to the second end.

Preferably, the first portion deviates from the longitudinal axis so as to form a curved taper towards a vehicle roof. Preferably, the second portion deviates from the longitudinal axis so as to form a curved taper towards a vehicle roof. Preferably, the first end is shaped so as to match the curvature of a vehicle roof. More preferably, the first end is cut to match the curvature of the vehicle roof. Preferably, the second end is shaped so as to match the curvature of a vehicle roof. More preferably, the second end is cut to match the curvature of the vehicle roof. Preferably, the entire tubular member appears to be in contact with the vehicle roof.

Preferably, fixing means are provided to fix at least a part of the tubular member to a vehicle roof. Preferably, the fixing means are double ended threaded studs. Preferably, the double-ended threaded studs have a flange that acts as a small spacer between the roof rail and the roof panel. Advantageously, the spacer compensates for manufacturing tolerances of the roof rail and vehicle body. Alternatively, the fixing means is another type of threaded stud or mechanical fastener. Alternatively, the fixing means is an adhesive bond between the roof rail and the vehicle roof.

Preferably, an extrusion or moulding, preferably, manufactured from rubber, polymer, or rubber foam, is used between the roof rail and the vehicle roof. This gives the appearance of an even distance, and hides any gap, between the rail and the roof but also prevents foreign objects from being lodged between the rail and roof. More preferably, a two-component polymer extrusion is used. Preferably, the tubular member has an R-shaped cross-section. This has the advantage that a lateral cross bar may be readily clamped to the roof rail.

According to a third aspect of the invention an elevated-type roof rail for a vehicle is provided comprising a tubular member having a longitudinal axis, a first end, a second end, the first end in close proximity to the vehicle roof, the first end forming a support member for fixing to the vehicle roof, a first portion adjacent and integral with the first end, the first portion deviating from the longitudinal axis so as to form a bend, the tubular member further comprising a second portion adjacent and integral with the second end, the second end being spaced at a distance from a vehicle roof, wherein the cross-sectional shape and size of the tubular member is substantially constant from the first end to the second end.

Preferably, the second portion runs generally parallel to the roof of a vehicle. Preferably, the first end is shaped so as to match the curvature of a vehicle roof. More preferably, the first end is cut to match the curvature of the vehicle roof. Preferably, the first end is spaced less than 15 mm from a vehicle roof. In a most preferred arrangement, the first end is spaced less than 3 mm from a vehicle roof. In this arrangement, any remaining gap may be filled using an additional component, for example a rubber gasket, which may be added to the said end before the roof rail is fixed to a vehicle. Preferably, an end cap is provided on the second end to give a complete and finished appearance to the rail.

Preferably, the tubular member is fixed to the vehicle using attaching means. The attaching means are provided on either the vehicle roof or on the tubular member. Preferably, the attaching means at the first end is a bracket assembly. Preferably, the attaching means at the first end are provided on the tubular member, the attaching means being attached at the first end thereto by adhesive. Alternatively, the attaching means being attached at the first end thereto by mechanical fixings, such as a screw, or a barbed spring retaining device. More preferably, the attaching means at the first end are contained entirely within the walls of the tubular member. Preferably the attaching means can be attached to the vehicle roof, the attaching means being threaded studs or screws. Advantageously, the attaching means can be assembled in the first instance to the tubular member, or alternatively, in the first instance to the vehicle roof, allowing flexibility in the assembly process. Advantageously, it is not necessary to have the bracket assembly at the first end visible to the observer following the assembly operation and thus the roof rail has an appealing seamless finish.

Preferably, at least one separately formed support is provided at the second end. Preferably, the separately formed support is attached to the tubular member, the attaching means preferably being mechanical fixings such as screws or rivets. Preferably, the support is attached to the vehicle roof, preferably, the attaching means being screws or threaded studs. Preferably, the separately formed support is a bracket assembly. Preferably, the bracket assembly includes a structural bracket and at least one aesthetic cover. Preferably, the aesthetic cover can be fitted after the roof rail has been assembled on to the vehicle. Advantageously, this allows the bracket to be fixed to the vehicle from outside the vehicle, simplifying the assembly and disassembly processes. Alternatively, the support may be provided as a single component and attached to the vehicle from within the vehicle body. Advantageously, the support may be provided in either a matching finish or a contrasting finish in comparison to the tubular member.

Preferably, at least one additional and separately formed support may be provided along the longitudinal axis. Preferably, the additional support is located at a distance from both the first end or the second end. Provision of the additional support gives physical support to the roof rail and may be aesthetically pleasing to the observer. Alternatively, the roof rail may be only supported at the first end and at the second end, without an additional support.

According to a fourth aspect of the invention an elevated-type roof rail for a vehicle is provided comprising a tubular member having a longitudinal axis, a first end, a second end, the first end in close proximity to the vehicle roof, the first end forming a support member for fixing to the vehicle roof, a first portion adjacent and integral with the first end, the first portion deviating from the longitudinal axis so as to form a bend, the tubular member further comprising a second portion adjacent and integral with the second end, the second end in close proximity to the vehicle roof, the second end forming a support member for fixing to the vehicle roof, the second portion deviating from the longitudinal axis so as to form a bend, wherein the cross-sectional shape and size of the tubular member is substantially constant from the first end to the second end.

Preferably, the first end is shaped so as to match the curvature of a vehicle roof. More preferably, the first end is cut to match the curvature of the vehicle roof. Preferably, the second end is shaped so as to match the curvature of a vehicle roof. More preferably, the second end is cut to match the curvature of the vehicle roof. Preferably, at least the first end is spaced less than 15 mm from a vehicle roof. In a most preferred arrangement, the first end is spaced less than 3 mm from a vehicle roof. More preferably, the distance between the said ends and the roof is less than 15 mm, most preferably, less than 3 mm. In this arrangement, any gap remaining may be filled using an additional component, for example a rubber gasket, which may be added to the said end before the roof rail is fixed to a vehicle.

Preferably, the tubular member is fixed to the vehicle using attaching means. The attaching means are provided on either the vehicle roof or on the tubular member. Preferably, the attaching means at the first end is a bracket assembly. Preferably, the attaching means at the first end are provided on the tubular member, the attaching means being attached at the first end thereto by adhesive. Alternatively, the attaching means being attached at the first end thereto by mechanical fixings, such as a screw, or a barbed spring retaining device. More preferably, the attaching means at the first end are contained entirely within the walls of the tubular member. Preferably, the attaching means at the second end are substantially similar to the attaching means at the first end. Preferably, the attaching means can be attached to the vehicle roof, the attaching means being threaded studs or screws. Advantageously the attaching means can be assembled in the first instance to the tubular member, or alternatively, in the first instance to the vehicle roof, allowing flexibility in the assembly process. Advantageously, it is not necessary to have the bracket assembly at the first end, or at the second end, visible to the observer following the assembly operation and thus the roof rail has an appealing seamless finish. This is visually striking.

Preferably, at least one additional and separately formed support may be provided along the longitudinal axis. Preferably, the additional support is located at a distance from both the first end or the second end. Provision of the additional rail foot gives physical support to the roof rail and may be aesthetically pleasing to the observer. Alternatively, the roof rail may be only supported at the first end and at the second end, without an additional support.

According to a fifth aspect, the invention provides a roof rail for a vehicle comprising a tubular member having a longitudinal axis, a first end and a second end, the cross-sectional shape and size of the tubular member being substantially constant from the first end to the second end, wherein a portion of the tubular member deviates from the longitudinal axis in the form of at least one twist. The arrangement creates the impression that there is a change in the cross section of the roof rail. This is visually appealing to the observer.

Preferably, the tubular member has a cross-section having a major axis and a minor axis. Preferably, the twist is a rotation of the said axes about an axis parallel to the longitudinal axis of the bent tubular member. Preferably, the major axis is substantially greater than the minor axis. More preferably, the major axis is at least 20% greater than the minor axis. Preferably, the twist rotates in a direction that is substantially perpendicular to the longitudinal axis. Preferably, the angle of the rotation is at least 10° between a first point and a second point on the tubular member. Preferably, the portion of the tubular member deviates from the longitudinal axis in the form of at least one twist and a bend.

In this configuration, the roof rail is aesthetically very pleasing to the observer because the arrangement creates the visual impression that there is a change in cross section along the roof rail because the side view presented to the observer varies along the length of the tubular member. Moreover, the twist and bend in the rail gives the appearance of an increase in the cross-sectional size so that, when viewed from the side of the vehicle, the tubular member appears to become wider where the bend and the twist occur. This creates the appearance of a support or roof rail foot. This configuration can be applied to either an elevated or an integrated type roof rail. This is visually striking.

All of the features described in the fifth aspect may be combined with any of the previous four aspects in any combination.

According to a sixth aspect, the invention further provides a method of defining the shape of a roof rail for a vehicle as a 3-dimensional computer model, the roof rail comprising a tubular member having at least one terminal bend and at least one twist and having a cross-sectional profile, the method comprising the steps of:
a) defining a primary guide curve, the said curve varying in either 2-dimensions, being a planar curve, or 3-dimensions, which follows a trajectory which is substantially parallel to a substantial portion of a vehicle roof, a first end of said curve comprising a bend which extends towards the vehicle roof;
b) defining on a 2-dimensional plane the cross-sectional profile of the tubular member, the profile including a radius, the centre of the radius being defined as a section origin;
c) positioning the profile on the primary guide curve such that the primary guide curve passes through the section origin;
d) creating a section directional vector which comprises a line extending from the section origin, and located on a plane which is perpendicular to the primary guide curve;
e) creating a secondary guide curve which varies in substantially 2-dimensions or 3-dimensions, the section directional vector passing through the secondary guide curve;
f) mapping a trajectory of the secondary guide curve in which said secondary guide curve is substantially equidistant from or parallel to the primary guide curve along its length when the primary guide curve is substantially parallel to the vehicle roof, and, when the primary guide curve forms the bend, the secondary guide curve deviates to create a twist which rotates about the primary guide curve.

Preferably, the roof rail is an elevated roof rail. Preferably, the bend passes through the vehicle roof. Preferably, the secondary guide curve is substantially perpendicular to the primary guide curve along its length when the primary guide curve is substantially parallel to the vehicle roof. Preferably, the at least one bend and the at least one twist occur at the same end of the tubular member. Preferably, a twist is provided at a first end or a second end of the roof rail. Preferably, the twist is applied to both the first and second said ends. More than one twist or bend may be provided at either or both said ends.

Advantageously, the computer model is simple to create and time can be saved during the design process, in comparison to a conventional roof rail. Advantageously, the cross-sectional profile can be simply modified to create different appearances and footprint shapes without major re-modelling. Advantageously, the bend and twist can be simply modified to suit the vehicle styling.

According to a seventh aspect, the invention further provides a method of manufacturing a roof rail, comprising the steps of:
a) producing a straight tubular member from a material;
b) manipulating the tubular member to a desired shape by a tube bending process;
c) cutting the tubular member to the desired length;
d) cutting the tubular member to the desired shape to match the vehicle roof;
e) surface finishing the tubular member; and
f) assembling the roof rail sub-components.

Preferably, the method also incorporates a step of twisting the tubular member about the longitudinal axis thereof.

Advantageously, a roof rail that features a twist or a series of twists can be manipulated to the desired shape during the tube bending process described above, provided that a suitable manipulation machine is specified.

Advantageously, a roof rail which features a second portion running generally parallel to the roof of the vehicle allows the left-handed and right-handed variants to be bent as one piece (i.e. mostly straight end to mostly straight end) before being separated and cut to shape. This reduces the cost of manufacturing and applies to both the elevated and integrated roof rail types.

Advantageously, the manufacturing process is simple and does not include hydroforming. Therefore, the cost of manufacturing is minimised and the roof rail is inexpensive to produce. Furthermore, the roof rail is light in weight.

Preferably, the material is a metal and, preferably, is aluminium as it can be readily and easily extruded and manipulated. More preferably, for use with aluminium, stretch bending over a former is preferred. Furthermore, laser cutting is the preferred cutting method with aluminium.

Alternatively, the metal is steel, or, preferably, stainless steel. Preferably, for use with metal material, the tube bending process is stretch-bending over a former. Alternatively, the tube bending process is press-bending over a former. Alternatively, roll bending is used.

Alternatively, the material is a polymer or a composite material. Preferably, for use with polymer or composite material, a thermoforming process is used whereby the tubular material is heated and laid in a former. Alternatively, vacuum forming is used.

The cutting process may be laser cutting but other suitable cutting methods are acceptable, including, water-jet cutting, CNC machining or sawing. Furthermore, a variety of finishes can be applied to the roof rail during manufacture. Preferably, these finishes include anodised aluminium or painted finish.

Additional items may be added to the surface of the tube to enhance the design, for example, external features that enable the locking of load carriers in pre-determined positions, or non-structural decorative trim features to enhance the styling of the roof rail.

In aspects of the invention where the first end, or second end, meets the contours of the vehicle roof, it does so in a precise manner so as to increase the illusion that the roof rail strikes and pierces the roof.

The roof rail may curve slightly along its length before the first or second end. The longitudinal axis of the roof rail may in that situation be curved. The curve preferably follows that of a roof to which the roof rail is to be fitted. The curve is designed to suit the roof to which it is fitted.

All of the features described herein may be combined with any of the above aspects in any combination.

Embodiments of the invention will now be described, by way of example only, with reference to the accompanying drawings, wherein:

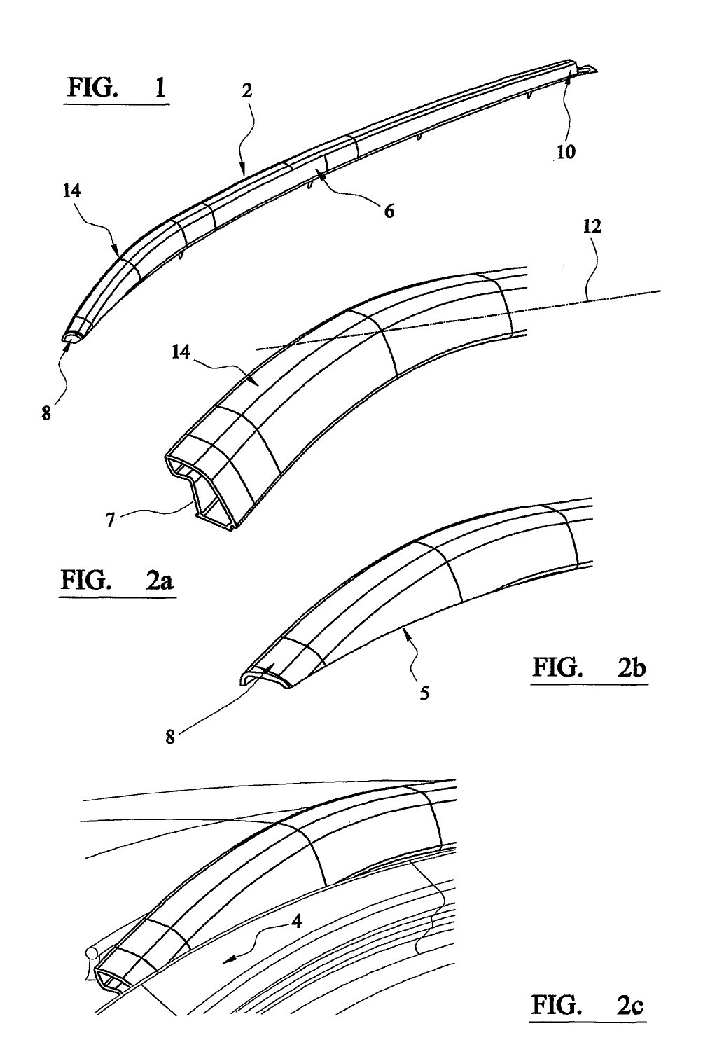

FIG. 1 is a perspective side view of a roof rail according to a first embodiment of the invention;

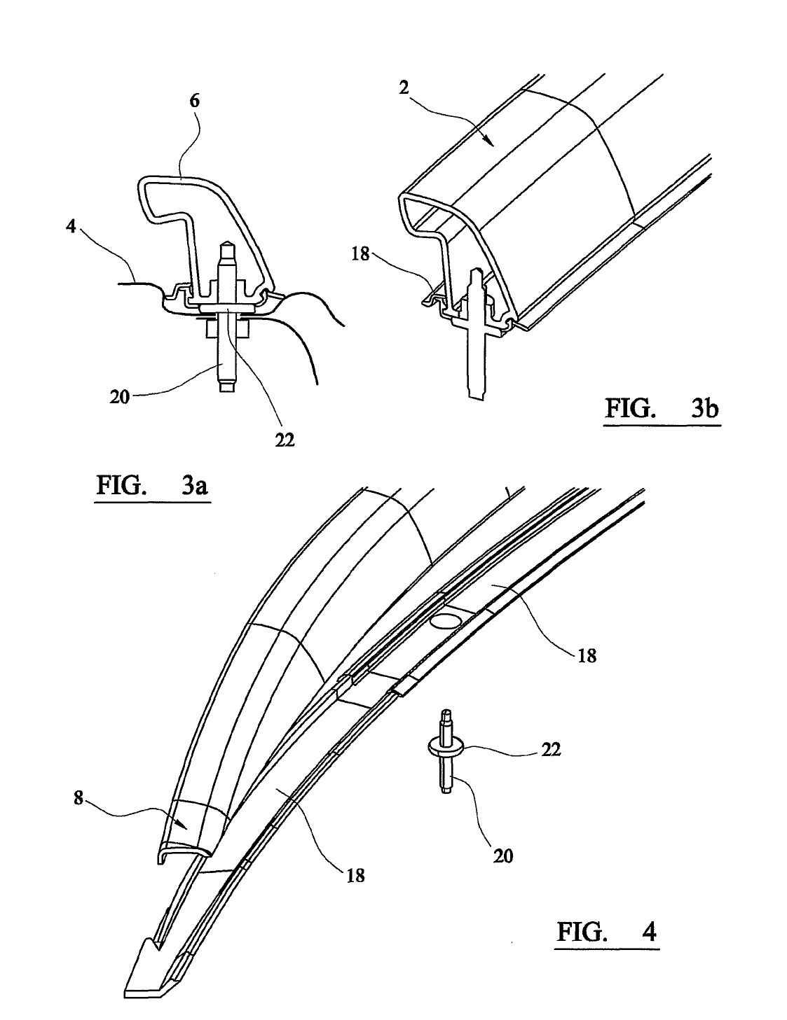

FIGS. 2a, 2b and 2c are perspective front views of the invention according to FIG. 1;

FIGS. 3a and 3b show a schematic sectional side and a schematic perspective view respectively of the invention according to FIG. 1;

FIG. 4 is an exploded view of the invention according to FIG. 1;

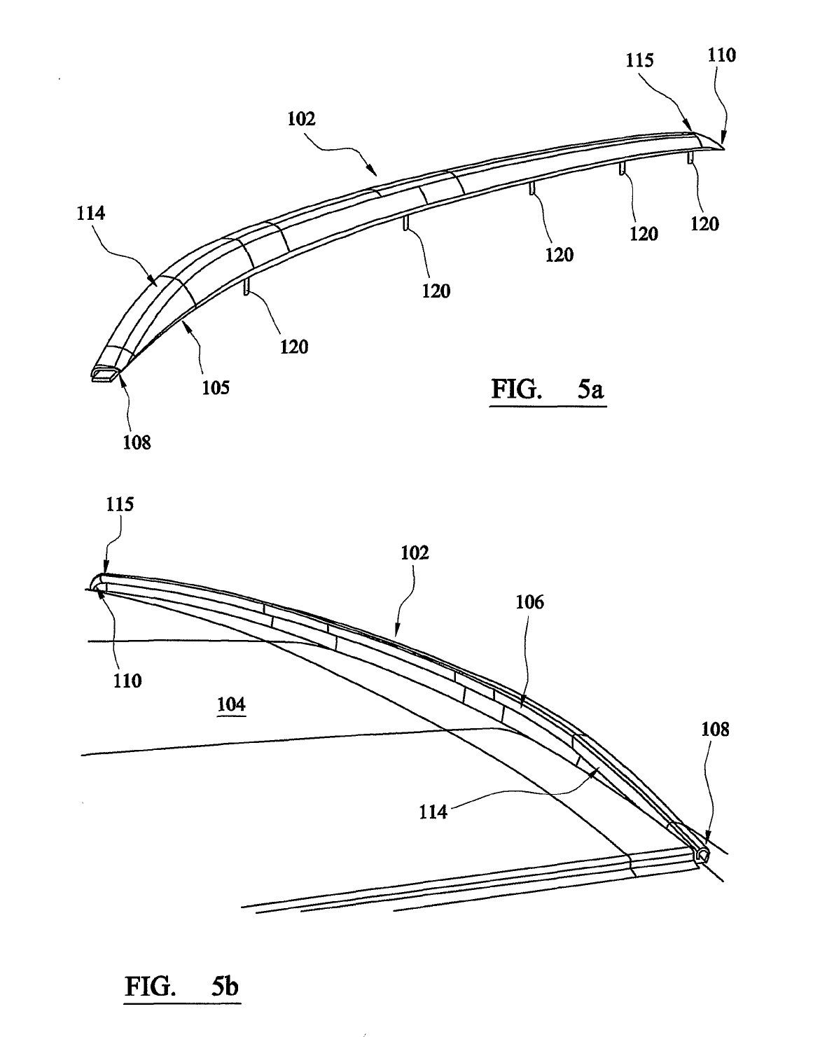

FIGS. 5a and 5b show perspective views of a roof rail according to a second embodiment of the invention;

FIG. 6 shows a perspective view of a roof rail according to a third embodiment of the invention;

FIG. 7 is a schematic sectional side view of a roof rail according to FIG. 6;

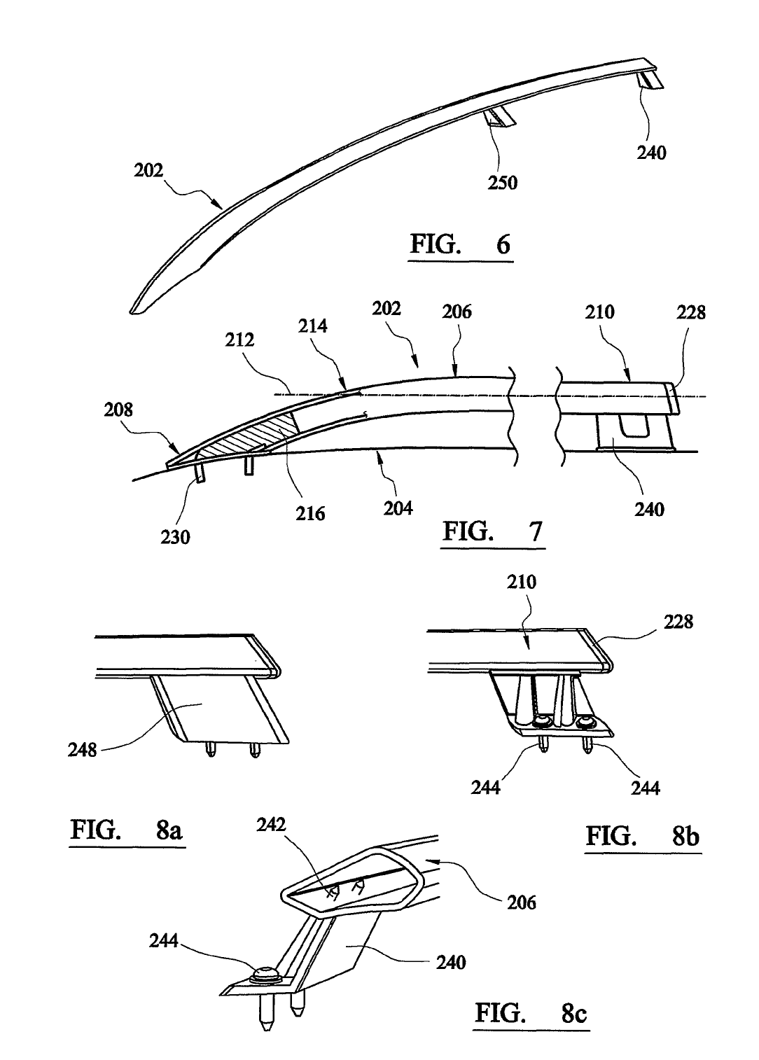

FIGS. 8a, 8b and 8c show a side view, a sectional side view and a sectional end view respectively of the invention according to FIG. 6;

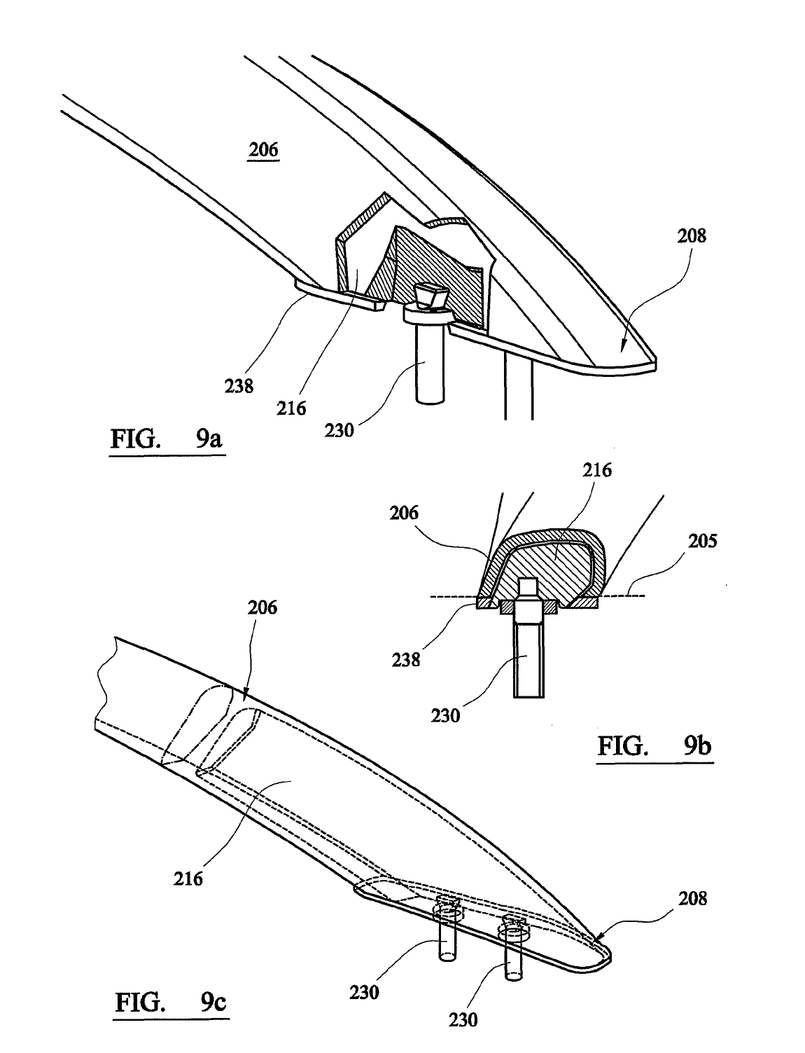

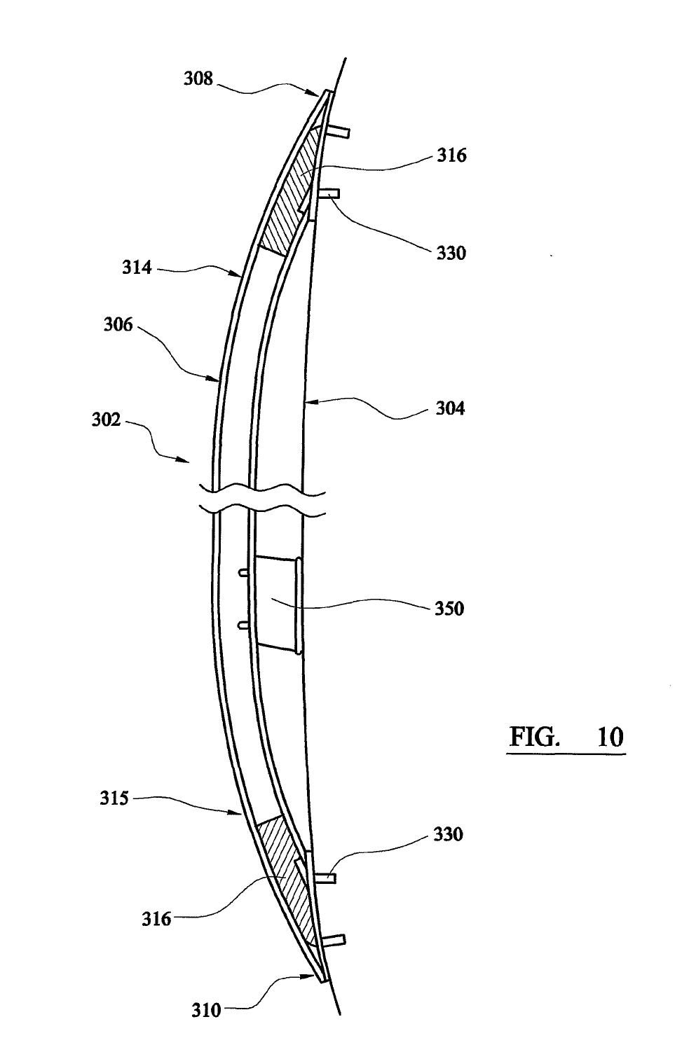

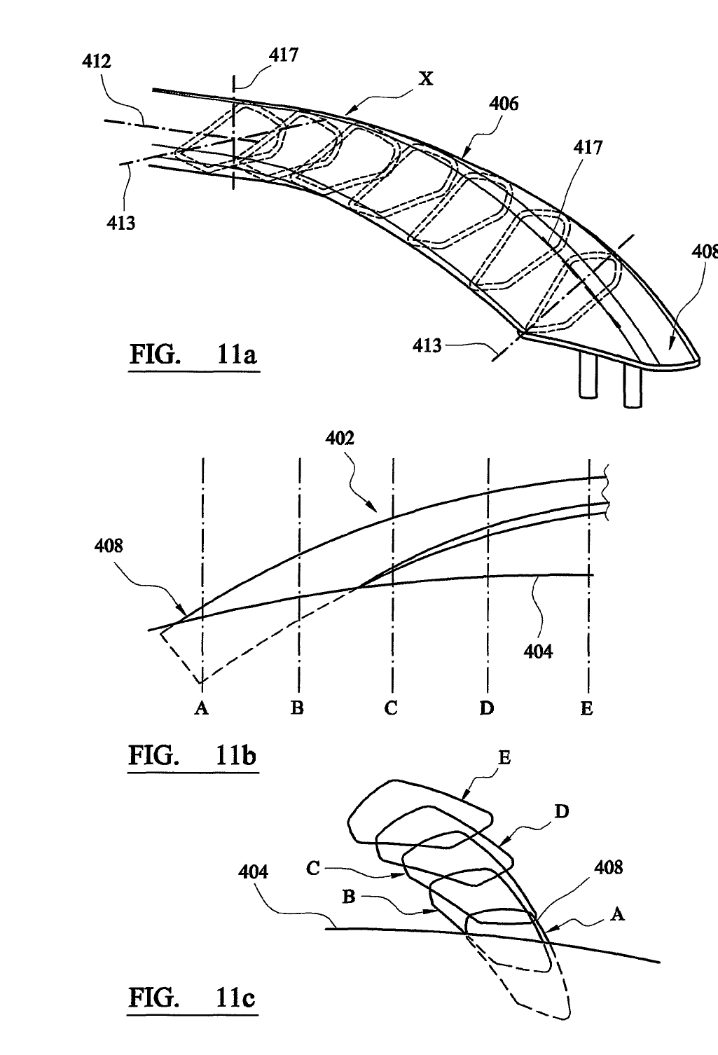

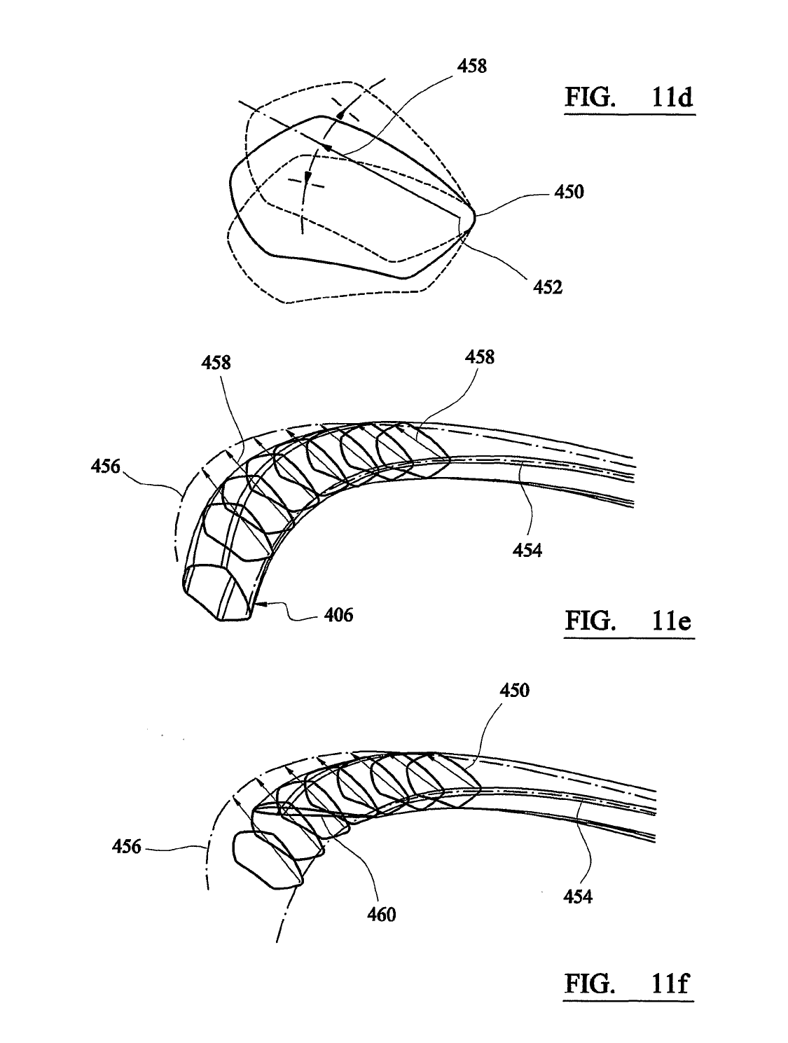

FIGS. 9a, 9b and 9c show a perspective cut-away sectional view, a front sectional view and a perspective sectional view respectively of the invention according to FIG. 6;

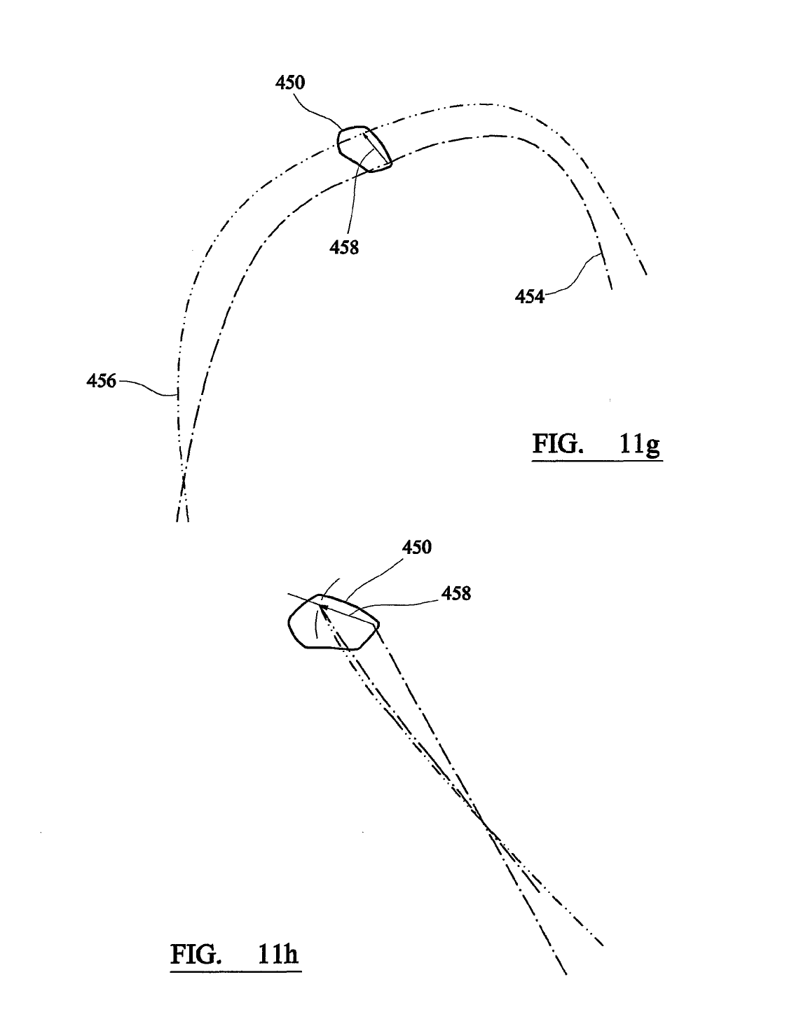

FIG. 10 shows a schematic sectional side view of a roof rail according to a fourth embodiment of the invention;

FIGS. 11a, 11b and 11c, 11d, 11e, 11f, 11g, 11h show a schematic sectional side profile and a progressive sectional view respectively of a roof rail according to a further aspect of the invention;

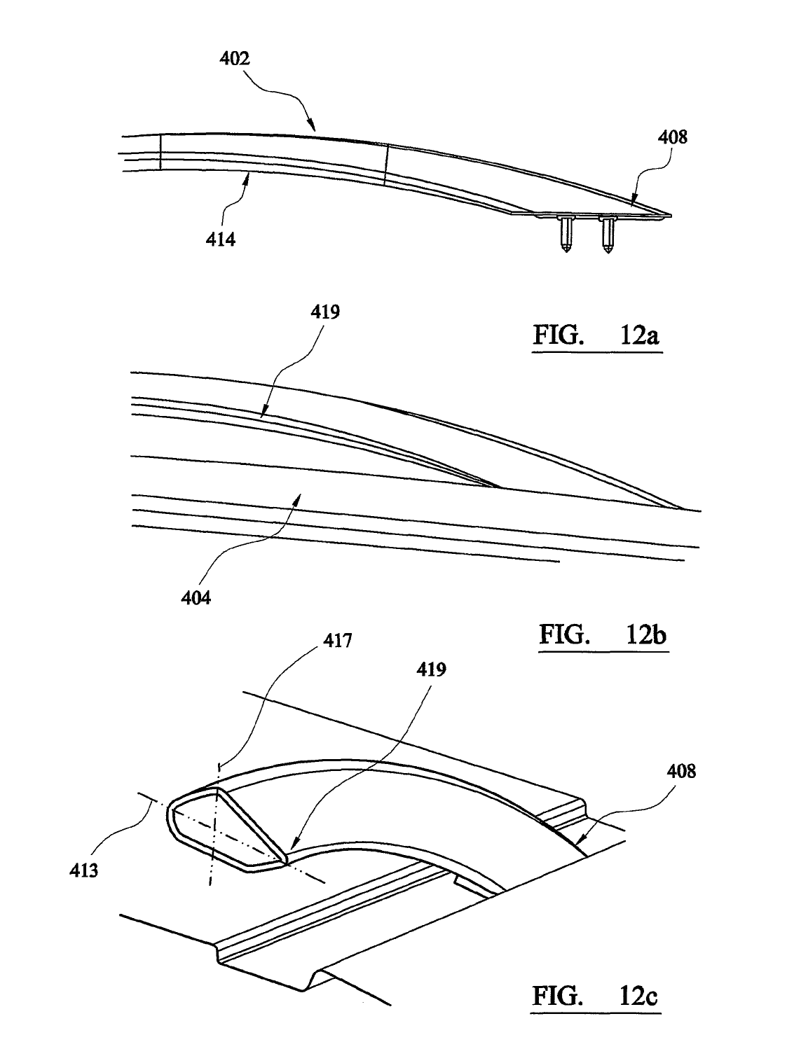

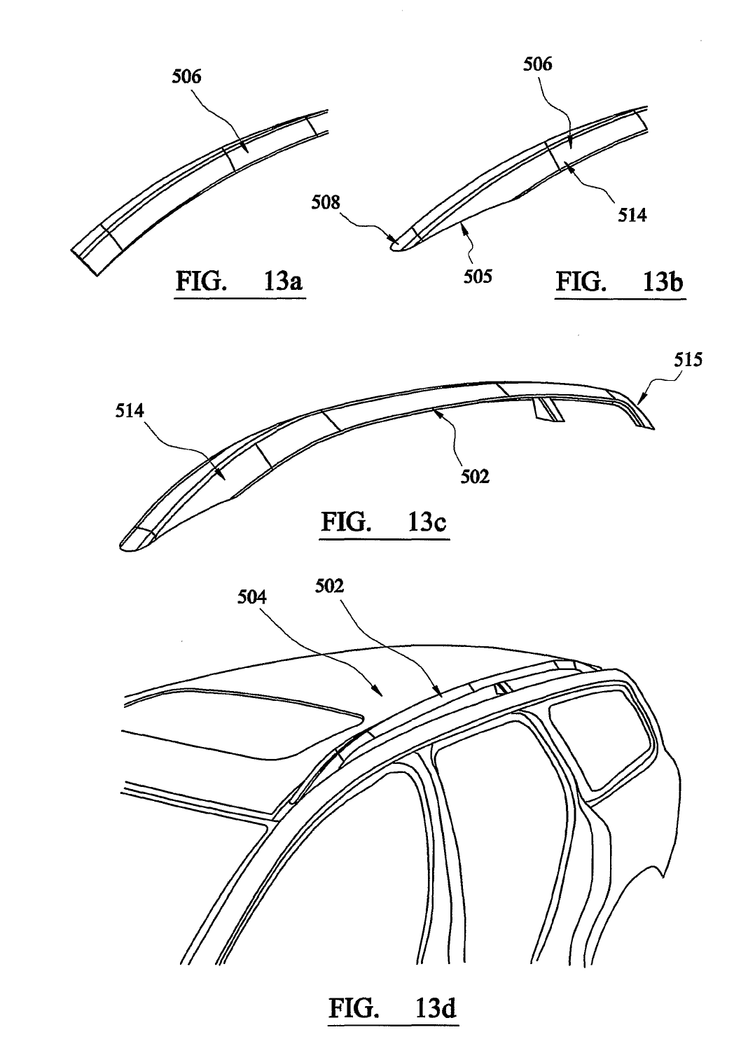

FIGS. 12a, 12b and 12c show a wire frame side view, rendered side view and a perspective sectional view respectively of the invention according to FIG. 11; and

FIGS. 13a, 13b, 13c and 13d show partial perspective and full perspective views of a roof rail according to a fifth embodiment of the invention.

FIGS. 1 to 4 show a first embodiment of a roof rail 2. The roof rail 2 is an integrated type of roof rail. Although only one roof rail 2 is shown in the figure, it will be appreciated that at least a pair of roof rails are provided.

The roof rail 2 comprises a tubular member 6 having an R-shaped cross-section 7, a first end 8 and a second end 10 and a longitudinal axis 12 about which the roof rail 2 curves. A first portion 14 of the tubular member 6 bends away from the longitudinal axis 12 so as to curve towards the roof 4. The first end 8 is cut 5 in such a manner so as to give the impression that the roof rail 2 pierces the vehicle roof 4.

FIG. 2a shows the first portion 14 of the roof rail 2 following the manipulation stage of the manufacturing process. FIG. 2b shows the first portion 14 of the roof rail 2 where the first end 8 has been cut 5 to suit the shape of a vehicle roof 4. FIG. 2c shows the first portion 14 of the roof rail 2 in position on the vehicle roof 4.

The tubular member 6 is attached to the vehicle roof 4 as shown in FIGS. 3a, 3b and 4 using double-ended studs 20. The double-ended threaded studs 20 have a flange 22 that acts as a small spacer between the roof rail 2 and the roof 4. The spacer compensates for manufacturing tolerances of the roof rail 2 and vehicle body. A two-component polymer extrusion 18 is used to give the appearance of an even gap and prevent foreign objects from being lodged between the roof rail 2 and the vehicle body. Alternative fixing methods may be used.

A second embodiment of the invention is shown in FIGS. 5a and 5b. The roof rail 102 is an integrated type roof rail and has identical parts to that shown in the first embodiment with the addition of a second portion 115 of the tubular member 106 which bends away from the longitudinal axis 112 so as to curve towards the roof 104. The first end 108 and the second end 110 both are cut 105 in such a manner so as to give the impression that the roof rail 102 pierces the vehicle roof 104. The roof rail is attached to the vehicle roof 104 in the same manner as that described in the first embodiment using double-ended studs 120.

A third embodiment of the invention is shown in FIGS. 6 to 9c. The roof rail 202 is an elevated type of roof rail and comprises a tubular member 206 with a first end 208, a second end 210 and a longitudinal axis 212. A first portion 214 of the tubular member 206 bends away from the longitudinal axis 212 so as to curve towards the roof 204. The first end 208 is cut 205 in such a manner so as to give the impression that the roof rail 202 pierces the vehicle roof 204. The first end 208 is attached to the roof 204 using attaching means 230 incorporated into a bracket assembly 216. The bracket assembly 216 is shown as being contained entirely within the walls of the tubular member 206 being attached thereto by a suitable adhesive. The bracket assembly 216 is not visibly attached to the vehicle roof and thus the roof rail 202 has an appealing seamless finish. This can be seen in FIG. 6.

The second end 210 is generally parallel to the roof 204 and is cut and terminated with a metal or plastic cap 228. A separately formed support or foot 240 is fixed to the roof rail 202 towards the second end 210 of the roof 204 as shown. The foot 240 is fixed to the roof rail 202 by screws 242 and is fixed to the vehicle roof 204 by screws 244. A separately formed cover 248 may cover the fixing screws 244 and the structure of the foot 240. A further foot 250 may be provided on the tubular member 206 located at any suitable position on the tubular member 206, for example, two-thirds of the way along away from the first end 208 and towards the second end 210. A main length of the roof rail 202 may follow the shape of the roof 204, preferably by being curved.

A fourth embodiment of the invention is shown in FIG. 10. The roof rail 302 is an elevated roof rail, which has a bend at both a first portion 314 and a second portion 315. The rail 302 has similar fixings to those described in the third embodiment. Further, an additional support 350 may be fixed to the rail 302 in the same manner as that described in third embodiment.

FIGS. 11 to 12 show a fifth embodiment of the invention. A tubular member 406 has a first end 408 and second end 410 and a longitudinal axis 412. The tubular member 406 has a constant cross-sectional shape and size, which is shown to have a major axis 413 and a minor axis 417. The tubular member 406 bends in a plane perpendicular to a longitudinal axis 412 thereof in the region marked X. A portion of the tubular member 406 deviates from the longitudinal axis 412 in the form of at least one twist. The twist is a rotation of the said axes 413, 417 about an axis parallel to the longitudinal axis 412 of the tube 406. It can be seen in the figures, that the major axis 413 is substantially greater than the minor axis 417. The major axis 413 is at least 20% greater than the minor axis 417.

FIG. 11a show the curving profile of the roof rail 402 as the rail 402 is progressively bent and twisted towards an end of the tubular member 406. The twist is in the form of a rotation of the tubular member 406 about an axis parallel to the longitudinal axis. The twist follows a trajectory that is generally perpendicular to the longitudinal axis. There is at least ten degrees of twist between two points along the length of the tubular member 406.

Sections A to E shown in FIGS. 11b and 11c illustrate the changing rotation of the cross-section of the tubular member 406. It can also be seen that the cross-sectional shape and size of the tubular member 406 remains constant throughout its length. It will be understood by the reader that although the embodiment shows a bend and twist, the roof rail may incorporate only a twist to achieve the appearance of a change in cross-section. It is the twist and rotational nature of the roof rail which is the claimed novelty in this embodiment. The bend and twist can be provided at the first end only, or alternatively, at both the first and second ends.

The tubular member, particularly having the bend and twist of, for example, that described in the previous embodiment, can be modelled or designed by determining three main elements. Said elements comprise a primary guide curve 454, a cross-sectional profile 450 or “section”, and a secondary guide curve 456 as shown in FIGS. 11d to 11h.

The primary guide curve 454 is created as a planar curve or 2D curve. However, it will be understood that said curve may also be non-planar i.e. 3-dimensional. The curve 454 is generally parallel to the vehicle roof along a substantial proportion of its total length. At least one end of the curve bends to pass through the vehicle roof. The primary guide curve 454 defines the bend of the tubular member 406.

The cross-sectional profile or section 450 of a tube is defined on a 2D plane. This section 450 includes a small radius of typically approximately 3 mm, on the edge of the tube that will be closest to the observer side of the vehicle on the finished product, i.e. the edge closest to an observer who is standing at the side of the vehicle. The centre of this radius is defined as the section origin 452. A line 458 is created which is also located on the 2D plane and passes through the section origin 452, this is known as the section direction vector 458.

A secondary guide curve 456 is created that is generally planar (2D) and generally parallel to the primary guide curve 454 where the primary guide curve 454 is generally parallel to the vehicle roof. Where the primary guide curve 454 bends towards the roof, the secondary guide curve 456 deviates from its parallel and planar path and creates either a non-planar (3D) or a planar (2D) curve that rotates about the primary guide curve 454.

It will be appreciated that the secondary guide curve 456 will generally be 3-dimensional (i.e. it is 2-dimensional when substantially parallel to the roof and 3-dimensional where the twist is applied at an end of the roof rail). However, a 2-dimensional secondary guide curve is not excluded from the scope of protection of this application. The section 450 is positioned on the primary guide curve 454 so that the primary guide curve 454 passes precisely and perpendicularly through the section origin 452. This is true along the entire length of the tubular member 406.

The section direction vector 458 always passes through the secondary guide curve 456 however, it is not necessary for the secondary guide curve 456 to be perpendicular to the section 450, or for it to always pass through the same point on the section 450. The secondary guide curve 456 defines the twist of the tubular member 406.

The ends of the tube are cropped to suit the vehicle body design. This cut end 460 is shown in FIG. 11f. Sub-components can be modelled using conventional methods known to the skilled person.

Advantageously, the computer model is simple to create and time can be saved during the design process, in comparison to a conventional roof rail. Advantageously, the Section can be simply modified to create different appearances and footprint shapes without major re-modelling. Advantageously, the bend and twist can be simply modified to suit the vehicle styling.

FIGS. 12a, 12b and 12c show that by incorporating a V-shaped surface 419 on the observer's side of the roof rail, a shadow effect can be created which enhances the visual effect of the twist.

FIGS. 13a, 13b, 13c and 13d show a sixth embodiment of the invention. The roof rail is an elevated type of roof rail as previously described in the fourth embodiment but with the inclusion of the bend and twist feature previously described in the fifth embodiment. A tubular member 506 incorporates a bend and a twist at both the first portion 514 and the second portion 515. FIG. 13a shows the first portion 514 of tubular member 506 which has been bent and twisted. FIG. 13b shows the first portion 514 of tubular member 506 after it has been cut 505 to suit the roof 504. FIG. 13c shows the complete roof rail 502 and FIG. 13d shows the roof rail 502 in position on the vehicle roof 504.

Although it is not shown, it will be understood that the fifth embodiment can be incorporated into any of the previous embodiments, including an integrated type of rail of the type previously described. All other fittings and parts are the same as those detailed for the appropriate embodiments herein before described.

A manufacturing process for manufacturing a roof rail according to any one of the embodiments will now be described. A length of straight aluminium extrusion or rolled steel profile is loaded into a bending machine. Jaws at each end of the bending machine grab the profile and stretch the material. The jaws then wrap the profile around a form tool to create a bent profile. The jaws can rotate relative to each other and the form tool to allow the tube to be twisted. The form tool may have auxiliary moving pieces to aid the forming process. The part is then removed from the bending machine.

The bent tube is placed into a cutting jig or fixture. Each end of the tube is cut to the required shape using a laser or water-jet cutting device. The laser or water-jet nozzle is attached to a robot device that can move around a pre-determined course cutting through the tube material. Alternatively the ends may be sawn, mill machined, or cropped. Other features, such as holes may be added during this procedure.

A decorative finish may be applied such as wet paint, powder coating or anodising; it may be necessary to finish or polish the surface first to achieve the desired surface finish quality.

The sub components are then assembled. For the integrated roof rail, the double-ended studs (which have friction flow-drill tips and self-tapping threads) are driven into the lower surface of the rail using high-speed automatic screwdrivers. A plastic extrusion, incorporating flexible edges to take care of manufacturing tolerances, is clipped to the lower surface. A plastic or metal end cap may be fitted if the rail is only tapered to the roof at one end.

For the elevated roof rail, a bracket assembly, most likely an aluminium casting pre-fitted with threaded steel studs, is pushed into the end of the extrusion and fixed to the tube using adhesive, or a mechanical fixing. A polymer or rubber gasket is fitted to the foot to protect the vehicle paintwork and take care of manufacturing tolerances. Water seals and a conventional middle foot may be added if required.

Advantageously, an integrated roof rail can replace the trim finisher normally required to hide the roof weld seam, reducing costs for the vehicle manufacturer.

The reader's attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. An integrated-type roof rail for a vehicle comprising a tubular member having a longitudinal axis, a first end, a second end, the first end in close proximity to a vehicle roof, a first portion adjacent and integral with the first end, the first portion deviating from the longitudinal axis so as to form a bend, the tubular member further comprising a second portion adjacent and integral with the second end, wherein the cross-sectional shape and size of the tubular member is substantially constant from the first end to the second end.

2. An integrated-type roof rail as claimed in claim 1, wherein the first portion deviates from the longitudinal axis so as to form a curved taper towards a vehicle roof.

3. An integrated-type roof rail as claimed in claims 1 or 2, wherein the second portion runs generally parallel to the roof of a vehicle.

4. An integrated-type roof rail as claimed in any one of the preceding claims, wherein the first end is shaped so as to match the curvature of a vehicle roof.

5. An integrated-type roof rail as claimed in claim 4, wherein the first end is cut to match the curvature of the vehicle roof.

6. An integrated-type roof rail as claimed in any one of the preceding claims, wherein the first end is spaced less than 15 mm from a vehicle roof.

7. An integrated-type roof rail for a vehicle as claimed in claim 6, wherein the first end is spaced less than 3 mm from a vehicle roof.

8. An integrated-type roof rail as claimed in any one of the preceding claims, wherein an end cap is provided on the second end and is adapted to provide a complete and finished appearance to the said rail.

9. An integrated-type roof rail as claimed in any one of the preceding claims, wherein fixing means are provided to fix at least a part of the tubular member to a vehicle roof.

10. An integrated-type roof rail as claimed in claim 9, wherein the fixing means are double ended threaded studs.

11. An integrated-type roof rail as claimed in any one of the preceding claims, wherein an extrusion is provided and which is adapted to fit between a roof rail and a vehicle roof.

12. An integrated-type roof rail as claimed in any one of the preceding claims, wherein the tubular member has an R-shaped cross-section.

13. An integrated-type roof rail comprising a tubular member having a longitudinal axis, a first end, a second end, the first end in close proximity to the vehicle roof, a first portion adjacent and integral with the first end, the first portion deviating from the longitudinal axis so as to form a bend, the tubular member further comprising a second portion adjacent and integral with the second end, the second end in close proximity to the vehicle roof, the second portion deviating from the longitudinal axis so as to form a bend, wherein the cross-sectional shape and size of the tubular member is substantially constant from the first end to the second end.

14. An integrated-type roof rail as claimed in claim 13, wherein the first portion is adapted to deviate from the longitudinal axis so as to form a curved taper towards a vehicle roof.

15. An integrated-type roof rail as claimed in claims 13 or 14, wherein the second portion deviates from the longitudinal axis so as to form a curved taper towards a vehicle roof.

16. An integrated-type roof rail as claimed in any one of claims 13 to 15, wherein the first end is cut to match the curvature of a vehicle roof.

17. An integrated-type roof rail as claimed in any one of claims 13 to 16, wherein the second end is cut to match the curvature of a vehicle roof.

18. An integrated-type roof rail as claimed in any one of claims 13 to 17, wherein fixing means are provided and are adapted to fix at least a part of the tubular member to a vehicle roof.

19. An integrated-type roof rail for a vehicle as claimed in any one of claims 13 to 18, wherein an extrusion is provided and is adapted to fit between a roof rail and a vehicle roof.

20. An elevated-type roof rail for a vehicle comprising a tubular member having a longitudinal axis, a first end, a second end, the first end in close proximity to the vehicle roof, the first end forming a support member for fixing to the vehicle roof, a first portion adjacent and integral with the first end, the first portion deviating from the longitudinal axis so as to form a bend, the tubular member further comprising a second portion adjacent and integral with the second end, the second end being spaced at a distance from a vehicle roof, wherein the cross-sectional shape and size of the tubular member is substantially constant from the first end to the second end.

21. An elevated-type roof rail for a vehicle as claimed in claim 20, wherein a second portion is adapted to run generally parallel to a roof of a vehicle.

22. An elevated-type roof rail for a vehicle as claimed in claims 20 or 21, wherein the first end is cut to match the curvature of a vehicle roof.

23. An elevated-type roof rail for a vehicle as claimed n any one of claims 20 to 22, wherein the first end is spaced less than 15 mm from a vehicle roof.

24. An elevated-type roof rail for a vehicle as claimed in any one of claims 20 to 23, wherein the first end is spaced substantially less than 3 mm from a vehicle roof.

25. An elevated-type roof rail for a vehicle as claimed in any one of claims 20 to 24, wherein the tubular member is adapted to be fixed to the vehicle using attaching means, the attaching means being provided on either the vehicle roof or on the tubular member.

26. An elevated-type roof rail for a vehicle as claimed in claim 25, wherein the attaching means are attached at the first end and are contained entirely within walls of the tubular member.

27. An elevated-type roof rail for a vehicle as claimed in any one of claims 20 to 26, wherein at least one separately formed support is provided at the second end.

28. An elevated-type roof rail for a vehicle as claimed in claim 27, wherein the separately formed support is adapted to attach to the tubular member.

29. An elevated-type roof rail for a vehicle as claimed in claims 27 or 28, wherein the separately formed support comprises a bracket assembly and at least one cover

30. An elevated-type roof rail for a vehicle as claimed in claims 29, wherein at least one cover is adapted to be fitted to the roof rail when the roof rail is assembled to a vehicle.

31. An elevated-type roof rail for a vehicle as claimed in any one of claims 20 to 30, wherein at least one additional and separately formed support is provided along the longitudinal axis.

32. An elevated-type roof rail for a vehicle as claimed in claim 31, wherein the additional support is located at a distance from the first end or the second end.

33. An elevated-type roof rail for a vehicle comprising a tubular member having a longitudinal axis, a first end, a second end, the first end in close proximity to the vehicle roof, the first end forming a support member for fixing to the vehicle roof, a first portion adjacent and integral with the first end, the first portion deviating from the longitudinal axis so as to form a bend, the tubular member further comprising a second portion adjacent and integral with the second end, the second end in close proximity to the vehicle roof, the second end forming a support member for fixing to the vehicle roof, the second portion deviating from the longitudinal axis so as to form a bend, wherein the cross-sectional shape and size of the tubular member is substantially constant from the first end to the second end.

34. An elevated-type roof rail for a vehicle as claimed in claims 33, wherein the first end and the second end are shaped so as to match the curvature of a vehicle roof.

35. An elevated-type roof rail for a vehicle as claimed in claims 33 or 34, wherein the first end is spaced less than 15 mm from a vehicle roof.

36. An elevated-type roof rail for a vehicle as claimed in claims 35, wherein the first end is spaced substantially less than 3 mm from a vehicle roof.

37. An elevated-type roof rail for a vehicle as claimed in claims 33 to 36, wherein the tubular member is adapted to be fixed to a vehicle using attaching means, the attaching means being provided on either the vehicle roof or on the tubular member.

38. An elevated-type roof rail for a vehicle as claimed in claim 37, wherein the attaching means are located at the first end and are contained entirely within the walls of the tubular member.

39. An elevated-type roof rail for a vehicle as claimed in claims 38, wherein the attaching means are further located at the second end and are contained entirely within the walls of the tubular member.

40. An elevated-type roof rail for a vehicle as claimed in any one of claims 32 to 39, wherein at least one additional and separately formed support is provided along the longitudinal axis.

41. A roof rail for a vehicle comprising a tubular member having a longitudinal axis, a first end and a second end, the cross-sectional shape and size of the tubular member being substantially constant from the first end to the second end, wherein a portion of the tubular member deviates from the longitudinal axis in the form of at least one twist.

42. A roof rail for a vehicle as claimed in claim 41, wherein the tubular member has a cross-section having a major axis and a minor axis and the twist is a rotation of the said axes about an axis parallel to the longitudinal axis of the bent tubular member.

43. A roof rail for a vehicle as claimed in claim 42, wherein the major axis is substantially greater than the minor axis.

44. A roof rail for a vehicle as claimed in any one of claims 41 to 43, wherein the twist rotates in a direction that is substantially perpendicular to the longitudinal axis.

45. A roof rail for a vehicle as claimed in any one of claims 41 to 44, wherein the portion of the tubular member deviates from the longitudinal axis in the form of at least one twist and a bend.

46. A roof rail for a vehicle as substantially as herein before described with reference to any one of the accompanying drawings.

47. A method of manufacturing a roof rail, comprising the steps of:
a) producing a straight tubular member from a material;
b) manipulating the tubular member to a desired shape by a tube bending process;
c) cutting the tubular member to the desired length;
d) cutting the tubular member to the desired shape to match a vehicle roof;
e) surface finishing the tubular member; and
f) assembling the roof rail sub-components.

48. A method as claimed in claim 47, further comprising a step of twisting the tubular member about the longitudinal axis thereof.

49. A method of defining the shape of a roof rail for a vehicle as a 3-dimensional computer model, the roof rail comprising a tubular member having at least one terminal bend and at least one twist and having a cross-sectional profile, the method comprising the steps of:
a) defining a primary guide curve, the said curve varying in either 2-dimensions, being a planar curve, or 3-dimensions, which follows a trajectory which is substantially parallel to a substantial portion of a vehicle roof, a first end of said curve comprising a bend which extends towards the vehicle roof;
b) defining on a 2-dimensional plane the cross-sectional profile of the tubular member, the profile including a radius, the centre of the radius being defined as a section origin;
c) positioning the profile on the primary guide curve such that the primary guide curve passes through the section origin;
d) creating a section directional vector which comprises a line extending from the section origin, and located on a plane which is perpendicular to the primary guide curve;
e) creating a secondary guide curve which varies in substantially 2-dimensions or 3-dimensions, the section directional vector passing through the secondary guide curve;
f) mapping a trajectory of the secondary guide curve in which said secondary guide curve is substantially equidistant from or parallel to the primary guide curve along its length when the primary guide curve is substantially parallel to the vehicle roof, and, when the primary guide curve forms the bend, the secondary guide curve deviates to create a twist which rotates about the primary guide curve.

50. A method as claimed in claim 49, wherein the roof rail is an elevated roof rail.
